(19) United States
(12) Patent Application Publication
(10) Pub. No.: US 2021/0321231 A1
(43) Pub. Date: Oct. 14, 2021

(54) 5G-BASED DATA COLLECTION DEVICE

(71) Applicant: Shenzhen Intelligent Manufacturing Velley industrial Internet Innovation Center Co., Ltd., Shenzhen (CN)

(72) Inventors: WEN-WU XU, Shenzhen (CN); XUE-QIN ZHANG, Shenzhen (CN); LI MA, Shenzhen (CN); HAI-RONG YE, Shenzhen (CN)

(21) Appl. No.: 17/032,368

(22) Filed: Sep. 25, 2020

(30) Foreign Application Priority Data
Apr. 14, 2020 (CN) 202010292257.4

(51) Int. Cl. H04W 4/38; H04W 4/02

(52) U.S. Cl. CPC H04W 4/38; H04W 4/02

(57) ABSTRACT

A 5G-based wireless sensor includes at least one data acquisition unit, a signal transmission unit, an antenna coupled to the signal transmission unit, and a processor. The at least one data acquisition unit comprises a signal output port. The processor connects to the signal output port of the at least one data acquisition unit, the signal transmission unit, and the antenna. The at least one data acquisition unit collects data and makes a structured processing of the data to acquire structured data. The processor constructs a table data according to the structured data and adds the table data to the structured data. The signal transmission unit converts the structured data in a 5G signal, and the antenna transmits the 5G signal.

### CROSS-REFERENCE TO RELATED APPLICATIONS

This application claims priority to Chinese Patent Application No. 202010292257.4 filed on Apr. 14, 2020, the contents of which are incorporated by reference herein.

### FIELD

The subject matter herein generally relates to a communication field, especially to a 5G-based data collection device.

### BACKGROUND

Generally, wireless sensors transmit data based on a Zigbee or a Lora. However, these wireless sensors merely achieve static data collection and data transmission at small data and low-power, which results in that the amount of data transmitted by the wireless sensors cannot meet high-speed, synchronous, real-time, large-scale data collection and transmission needs for a future bridge, geological disasters, AGV cars, car networking, high-speed processing machines, agricultural production machinery.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of a running environment of a 5G-based data collection device.

FIG. 2 is a block diagram of an embodiment of the 5G-based data collection device of FIG. 1.

FIG. 3a is a block diagram of a connection between an analog signal data collection channel and an analog sensor.

FIG. 3b is a block diagram of a connection between a digital signal data collection channel and a digital sensor.

FIG. 4 is a block diagram of a table.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or another storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

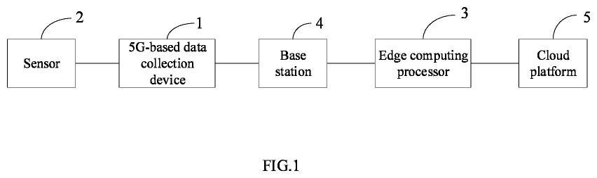

FIG. 1 illustrates a running environment of a 5G-based data collection device 1. The 5G-based data collection device 1 communicates with a sensor 2 and an edge computing processor 3. The 5G-based data collection device 1 receives data sent by the sensor 2 and sends the received data to the edge computing processor 3. In one embodiment, a base station 4 sends 5G signal to cover the area where the base station 4 is located, the 5G-based data collection device 1 communicates with the edge computing processor 3 by the 5G signal sent by the base station 4. The edge computing processor 3 processes the data sent by the 5G-based data collection device 1, and sends the processed data to a cloud platform 5. In one embodiment, the base station 4 is a 5G base station, and the cloud platform 5 is a cloud platform server. In one embodiment, the edge computing processor 3 communicates with the cloud platform 5 by a network (not shown in FIG. 1). In one embodiment, the network may be an internal network or the Internet. In one embodiment, the sensor 2 includes, but is not limited to, pressure and force-sensitive sensor, a humidity sensor, a magnetic sensor, a gas sensor, a thermal (temperature) sensor, a position sensor, a liquid level sensor, an energy consumption sensor, a speed sensor, an acceleration sensor, a radiation sensor, a vibration sensor, a vacuum sensor, a biosensor, a voice sensor, an ultrasonic sensors, and an image sensor.

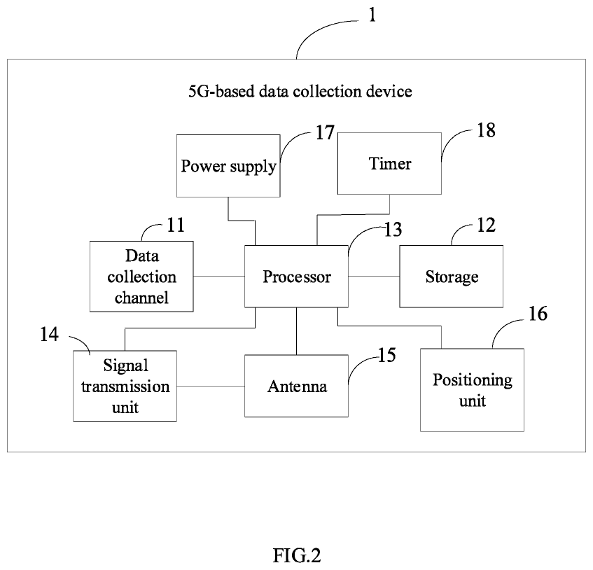

FIG. 2 illustrates the 5G-based data collection device 1. The 5G-based data collection device 1 includes a data collection channel 11, a storage 12, a processor 13, a signal transmission unit 14, an antenna 15, a positioning unit 16, a power supply 17 and a timer 18. In one embodiment, the data collection channel 11, the storage 12, the processor 13, the signal transmission unit 14, the antenna 15, the positioning unit 16, the power supply 17 and the timer 18 are installed on a circuit board of the 5G-based data collection device 1. The processor 13 is connected to the data collection channel 11, the storage 12, the signal transmission unit 14, the antenna 15, the positioning unit 16, the power supply 17, and the power supply 17.

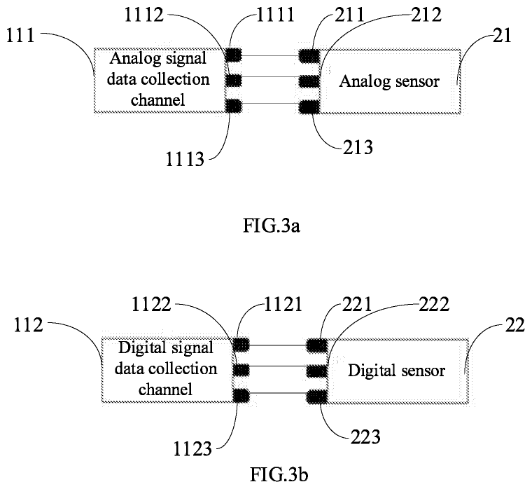

In one embodiment, the 5G-based data collection device 1 collects to the sensor 2 by the data collection channel 11. In one embodiment, the data collection channel 11 includes an analog signal data collection channel 111 and a digital signal data collection channel 112. The sensor 2 includes an analog sensor 21 and a digital sensor 22. The 5G-based data collection device 1 communicates with the analog sensor 21 by the analog signal data collection channel 111. FIG. 3a illustrates the connection between the analog signal data collection channel 111 and the analog sensor 21. The analog signal data collection channel 111 includes a first power end 1111, a first ground end 1112, and an analog signal input 1113. The analog sensor 21 includes a second power end 211, a second ground end 212, and an analog signal output 213. In one embodiment, the first power end 1111 of the analog signal data collection channel 111 connects to the second power end 211 of the analog sensor 21, the first ground end 1112 of the analog signal data collection channel 111 connects to the second ground end 212 of the analog sensor 21. The analog signal input 1113 of the analog signal data collection channel 111 connects to the analog signal output 213 of the analog sensor 21.

FIG. 3b illustrates the connection between the digital signal data collection channel 112 and the digital sensor 22. The 5G-based data collection device 1 communicates with the digital sensor 22 by the digital signal data collection channel 112. In one embodiment, the digital signal data collection channel 112 includes a third power end 1121, a third ground end 1122, and a digital signal input 1123. The digital sensor 22 includes a fourth power end 221, a fourth ground end 222, and a digital signal output 223. The third power end 1121 of the digital signal data collection channel 112 connects to the fourth power end 221 of the digital sensor 22. The third ground end 1122 of the digital signal data collection channel 112 connects to the fourth ground end 222 of the digital sensor 22. The digital signal input 1123 of the digital signal data collection channel 112 connects to the digital signal output 223 of the digital sensor 22.

In one embodiment, the sensor 2 connected with the data collection channel 11 can be replaced according to a preset replacement principle. In one embodiment, the preset replacement principle includes: the analog sensor 21 connected with the analog signal data collection channel 111 can be replaced by another analog sensor 21, and the digital sensor 22 connected with the digital signal data collection channel 112 can be replaced by another digital sensor 22. In one embodiment, the sensor 2 connected with the data collection channel 11 can be replaced depending on working requires. For example, a vibration sensor connected to the data collection channel 11 can be replaced with a vacuum sensor depending on working requires.

In one embodiment, the 5G-based data collection device 1 includes a number of the data collection channels 11. The number of the data collection channels 11 connects to a number of sensors 2 according to a preset connection principle. The preset connection principle includes: adding at least one data collection channel 11 to make the at least one data collection channel 11 to connect to at least one sensor 2, replacing at least one data collection channel 11 connecting to at least one sensor 2, reducing at least one data collection channel connecting to at least one sensor 2. In one embodiment, the data collection channel 11 is set in a card slot of the circuit board of the 5G-based data collection device 1. The data collection channel 11 can be plugged in the card slot of the circuit board and pull out of the card slot of the circuit board. In one embodiment, the number of the data collection channels 11 is less than the number of the card slots in the 5G-based data collection device 1.

In one embodiment, the storage 12 stores data and software code of the 5G-based data collection device 1. In one embodiment, the storage 12 can include various types of non-transitory computer-readable storage mediums. For example, the storage 12 can be an internal storage system of the 5G-based data collection device 1, such as a flash memory, a random access memory (RAM) for the temporary storage of information, and/or a read-only memory (ROM) for permanent storage of information. In another embodiment, the storage 12 can also be an external storage system, such as a hard disk, a storage card, or a data storage medium. In one embodiment, the processor 13 processes the data collected by the 5G-based data collection device 1. In one embodiment, the processor 13 can be a central processing unit, or a common processor, a digital signal processor, a dedicated integrated circuit, ready-made programmable gate arrays or other programmable logic devices, discrete door or transistor logic devices, discrete hardware components, and so on. In another embodiment, the processor can be any conventional processor. The processor can also be a control center of the 5G-based data collection device 1, using various interfaces and lines to connect the various parts of the 5G-based data collection device 1.

In one embodiment, the processor 13 makes structured processing of the data collected by the data collection channel 11 to acquire structured data. In one embodiment, the structured data includes description information and collecting information. In one embodiment, the description information includes an identification number of the data collection channel 11, a name of the sensor 2 connected to the data collection channel 11, an identification number of the sensor 2 connected to the data collection channel 11, a data unit of the data collected by the data collection channel 11, an accuracy of the data collected by the data collection channel 11, and a type of the data collected by the data collection channel 11. In one embodiment, since the description information in the structured data includes the identification number of the sensor 2, the name of the sensor 2, and the data unit of data collected by the data collection channel 11, so the description information of the structured data can clearly indicate the source of the data collected by the data collection channel 11.

In one embodiment, the collecting information includes a collection time information of the data, a position information of the data collected by the 5G-based data collection device 1, and a value of the data. In one embodiment, the processor 13 acquires the position information of the 5G-based data collection device 2 by the positioning unit 16, and regards the position information of the 5G-based data collection device 1 as the position information of the data. In one embodiment, the positioning unit 16 can be a GPS device. In another embodiment, the processor 13 acquires the position information of the 5G-based data collection device 1 by a GPS device or by a 5G signal precision positioning method, and regards the position information of the 5G-based data collection device 1 as the position information of the data. In other embodiment, the processor 13 acquires the position information of the 5G-based data collection device 1 by the base station 4, and regards the position information of the 5G-based data collection device 1 as the position information of the data.

In one embodiment, the processor 13 times when the 5G-based data collection device 1 collects the data to get timing time by the timer 18 of the 5G-based data collection device 1, and regards the timing time as the collection time information of the data collected by the data collection channel 11.

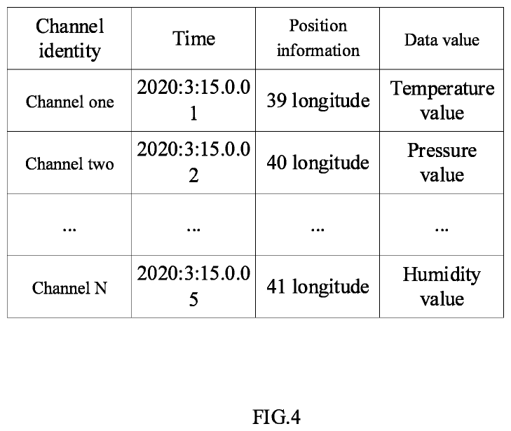

In one embodiment, the processor 13 constructs a table data according to the collecting information, and adds the table data to the structured data. In one embodiment, the processor 13 constructs the position information of the 5G-based data collection device 1 and the data value of the data collected by the 5G-based data collection device 11 into a two-dimensional table, and adds the two-dimensional table to the structured data. In one embodiment, the processor 13 constructs the collection time information of the data and the data value of the data collected by the 5G-based data collection device 1 into a two-dimensional table, and adds the two-dimensional table to the structured data. In one embodiment, the processor 13 constructs the position information of the 5G-based data collection device 1, the collection time information of the data, and the data value of the data collected by the 5G-based data collection device 1 into a three-dimensional table and adds the three-dimensional table to the structured data. FIG. 4 illustrates a table. In one embodiment, the processor 13 constructs each identification number of the sensor 2 connected to the data collection channel 11, the position information of the 5G-based data collection device 1, each collection time information of the data collected by the data collection channel 11, and each data value of the data collected by the data collection channel 11 into a four-dimensional table (referring), and adds the four-dimensional table to the structured data. In one embodiment, a (N+3)-dimensional table in the structured data of the 5G-based data collection device 1 with N data collection channels includes each collection time information of the data collected by the data collection channel 11, the position information of the data collected by the data collection channel 11, each data value of the data collected by the collection channels, the identification number of a data collection channel one, the identification number of a data collection channel two, . . . , the identification number of a data collection channel N, where N is an integer.

In one embodiment, the processor 13 also receives a setting instruction, and set a working mode of the data collection channel 11 as a synchronous acquisition mode or an asynchronous acquisition mode. In one embodiment, the synchronous acquisition mode of the data collection channel 11 is that the processor 13 controls each sensor 2 connected to the data collection channel 11 to collect data at the same time, and the asynchronous acquisition mode of the data collection channel 11 is that the processor 13 controls each sensor 2 connected to the data collection channel 11 to collect data at different time. In one embodiment, by a simultaneous collection of the data collected by the data collection channels 11, multiple physical characteristics of the data can be collected in the same time period and in the same spactial position. For example, collecting visual image data, temperature data, humidity data, biology data of a farm simultaneously by the data collection channels 11 of the 5G-based data collection device 1 will reduce time investment and human resources investment in data collection in scientific research, technology research and development, and greatly improves the efficiency of data collection.

In one embodiment, when detecting the number of the data collection channels increases or detecting that the sensor 2 connected to the data collection channel 11 changes, the processor 13 resets and initializes the 5G-based data collection device 1. In one embodiment, when resetting and initializing the 5G-based data collection device 1, the processor 13 acquires the identification number of the 5G-based data collection device 1, acquires the number of the data collection channels of the 5G-based data collection device 1, and rescans to acquire a name information, a data type information, a data unit information, a data accuracy information of the sensor 2 connected to the data collection channel 11. In one embodiment, the processor 13 further establishes a data collection architecture of the data collected by the data collection channel 11, where the data collection architecture of the data includes the identification number of the data collection channel 11, the name of the sensor 2 connected to the data collection channel 11, the identification number of the sensor 2 connected to the data collection channel 11, the data unit of the data collected by the data collection channel 11, the accuracy of the data collected by the data collection channel 11, the type of the data collected by the data collection channel 11, and a storage location of the data collected by the data collection channel 11.

In one embodiment, the processor 13 cleans the data collected by the data collection channel 11. In one embodiment, the processor 13 removes redundancy, fragmentation, and noise from the data according to a preset cleaning rule algorithm. In one embodiment, the preset cleaning rule algorithm can be a removing missing value method, a mean filling method, or a hot card filling method. In one embodiment, the removing missing value method is to directly drop samples with missing values from the data. The mean filling method is to divide the data into groups according to a property correlation coefficient of the missing value in the data, calculate a mean value of each group, and insert the mean as the missing value. The hot card filling method is to find an object in a database that has a value similar to the missing value, and then fill the value of the object into the missing value.

In one embodiment, the signal transmission unit 14 converts the structured data in a 5G signal. In one embodiment, the antenna 15 connects to the signal transmission unit 14. The antenna 15 transmits the 5G signal. For example, the antenna 15 transmits the 5G signal to the edge computing processor 3. In one embodiment, the signal transmission unit 14 is a 5G signal transmission module, and the antenna 15 is a 5G antenna. The power supply 17 provides electricity for the data collection unit 11, the storage 12, the processor 13, the signal transmission unit 14, the antenna 15, the positioning unit 16, and the timer 18. In one embodiment, the power supply 17 can be a switching power supply, a lithium battery, a solar cell, or a temperature-varying battery. It should be noted that the 5G-based data collection device 1 in the present invention does not limit in 5G communication systems, but can also be used in NB-iot, Wifi6, 4G 3G and future 6G and other wireless communication systems.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

1. A 5G-based data collection device comprising:
at least one data collection channel;
a signal transmission unit;
an antenna coupled to the signal transmission unit;
a processor coupled to the at least one data collection channel, the signal transmission unit, and the antenna, wherein the at least one data collection channel connects to a sensor, the at least one data collection channel collects data by the sensor, the processor makes a structured processing of the data collected by the data collection channel and acquires structured data, the signal transmission unit converts the structured data in a 5G signal, and the antenna transmits the 5G signal, wherein the at least one data collection channel is insertable in a card slot of a circuit board of the 5G-based data collection device or removable from the card slot of the circuit board, wherein the processor is configured to reset and initialize the 5G-based data collection device in response to a detected increased number of the data collection channels inserted in the card slots of the circuit board.

2. The 5G-based data collection device according to claim 1, wherein:
the structured data comprises description information and collecting information;
the description information comprises an identification number of the data collection channel, a name of the sensor connected to the data collection channel, an identification number of the sensor, a data unit of the data collected by the data collection channel, an accuracy of the data collected by the data collection channel, and a type of the data collected by the data collection channel;
the collecting information comprises a collection time information of the data, position information of the data, and a value of the data.

3. The 5G-based data collection device according to claim 2, wherein the processor further acquires a position information of the 5G-based data collection device by a positioning unit and determines the position information of the 5G-based data collection device as the position information of the data.

4. The 5G-based data collection device according to claim 2, wherein the processor times when the data collection channel collects the data to get timing time by a timer and determines the timing time as the collection time information of the data.

5. The 5G-based data collection device according to claim 2, wherein the processor further constructs the position information of the data and the data value of the data into a two-dimensional table and adds the two-dimensional table to the structured data.

6. The 5G-based data collection device according to claim 2, wherein the processor constructs the collection time information of the data and the data value of the data collected by the data collection channel into a two-dimensional table, and adds the two-dimensional table to the structured data.

7. The 5G-based data collection device according to claim 2, wherein the processor constructs the position information of the data, the collection time information of the data, and the data value of the data into a three-dimensional table, and adds the three-dimensional table to the structured data.

8. The 5G-based data collection device according to claim 2, wherein the processor constructs each identification number of the sensor connected to the data collection channel, the position information of the data, each collection time information of the data, and each data value of the data into a four-dimensional table, and adds the four-dimensional table to the structured data.

9. The 5G-based data collection device according to claim 2, wherein:
the processor receives a setting instruction and sets a working mode of the data collection channel as a synchronous acquisition mode or an asynchronous acquisition mode wherein the synchronous acquisition mode of the data collection channel is that the processor controls each sensor connected to the data collection channel to collect data at the same time, and
the asynchronous acquisition mode of the data collection channel is that the processor controls each sensor connected to the data collection channel to collect data at different time.

10. The 5G-based data collection device according to claim 2, wherein when detecting that the sensor connected to the data collection channel changes, the processor resets and initializes the 5G-based data collection device.

11. The 5G-based data collection device according to claim 10, wherein when resetting and initializing the 5G-based data collection device, the processor acquires an identification number of the 5G-based data collection device, acquires a number of the data collection channels of the 5G-based data collection device, and rescans to acquire a name information of the sensor, a data type information of the sensor connected to the data collection channel, a data unit information of the sensor connected to the data collection channel, and a data accuracy information of the sensor connected to the data collection channel.

12. The 5G-based data collection device according to claim 11, wherein when resetting and initializing the 5G-based data collection device, the processor further establishes a data collection architecture of the data, wherein the data collection architecture of the data comprises the identification number of the data collection channel, the name of the sensor connected to the data collection channel, the identification number of the sensor, the data unit of the data collected by the data collection channel, the accuracy of the data collected by the data collection channel, the type of the data collected by the data collection channel, and a storage location of the data collected by the data collection channel.

13. The 5G-based data collection device according to claim 1, wherein:
the data collection channel comprises an analog signal data collection channel and a digital signal data collection channel;
the sensor comprises an analog sensor and a digital sensor;
the 5G-based data collection device connects to the analog sensor by the analog signal data collection channel;
the 5G-based data collection device connects to the digital sensor by the digital signal data collection channel.

14. The 5G-based data collection device according to claim 13, wherein:
the analog signal data collection channel comprises a first power end, a first ground end, and an analog signal input;
the analog sensor comprises a second power end, a second ground end, and an analog signal output;
the first power end of the analog signal data collection channel connects to the second power end of the analog sensor;
the first ground end of the analog signal data collection channel connects to the second ground end of the analog sensor;
the analog signal input of the analog signal data collection channel connects to the analog signal output of the analog sensor.

15. The 5G-based data collection device according to claim 13, wherein:
the digital signal data collection channel comprises a third power end, a third ground end, and a digital signal input;
the digital sensor comprises a fourth power end, a fourth ground end, and a digital signal output; the third power end of the digital signal data collection channel connects to the fourth power end of the digital sensor;
the third ground end of the digital signal data collection channel connects to the fourth ground end of the digital sensor;
the digital signal input of the digital signal data collection channel connects to the digital signal output of the digital sensor.
